(19) United States
(12) Patent Application Publication
(10) Pub. No.: US 2025/0044658 A1
(43) Pub. Date: Feb. 6, 2025

(54) METHOD OF MANUFACTURING CURVED ELECTROCHROMIC DEVICES

(71) Applicant: MIRU SMART TECHNOLOGIES CORP., Vancouver (CA)

(72) Inventors: Curtis Paul BERLINGUETTE, Vancouver (CA); Pak Lun CHAU, Richmond (CA); Aaron Matthew Lorne KIRKEY, Vancouver (CA); Melissa Lan LEHNER, Vancouver (CA)

(21) Appl. No.: 18/716,999

(22) PCT Filed: Dec. 6, 2022
(86) PCT No.: PCT/CA2022/000068

§ 371 Date: Jun. 6, 2024

Related U.S. Application Data
(60) Provisional application No. 63/286,247, filed on Dec. 6, 2021.

(51) Int. Cl. G02F 1/153; G02F 1/155

(52) U.S. Cl. CPC G02F 1/1533; G02F 1/155

(57) ABSTRACT

Methods for manufacturing curved electrochromic devices by depositing solution-based material directly onto curved surfaces are disclosed. The curved electrochromic device is prepared by spray-coating the first curved electrically conductive substrate with a solution of one or more (cathodic) inorganic or organometallic precursors, and then exposing the coated substrate to near-infrared radiation, UV radiation, or ozone to convert the one or more (cathodic) inorganic or organometallic precursors to (cathodic) electrochromic layers. The second, complimentary electrically conductive curved substrate is coated with a second (anodic) electrochromic layer. An electrolyte layer is incorporated between said first electrochromic layer and said second electrochromic layer, the substrates are sealed together, to form a curved electrochromic device. This method Is especially useful for curved electrochromic devices employing bent tempered glass or heat strengthened glass.

### FIELD OF INVENTION

The present invention pertains to the field of electrochromic devices and in particular to methods for their manufacture.

### BACKGROUND

“Smart windows” or “smart glass” refer to devices where the colour and the amount of light transmission or reflection of the device can be altered by electronic switching. When the bias is electrical in nature (for example, a voltage is applied), the devices are referred to as electrochromic (EC) devices. These devices may be used for variable transmission windows for use in buildings and transportation (automotive, aeroplanes, passenger trains, ferries, etc), displays and automotive mirrors for controlling reflectivity. By adjusting the transmission of the windows, the solar energy that is transmitted through the window also changes.

There is an increasing demand for windows in new construction projects, and windows are widely regarded to be one of the least efficient components of a building envelope. Heating, ventilating, and air conditioning (HVAC) and lighting in buildings account for greater than 30 percent of global primary energy consumption, and up to half of this energy can be lost through windows. This energy loss results in high greenhouse gas (GHG) emissions and energy costs for building owners. The use of smart windows in residential and commercial buildings result in buildings with improved energy efficiency. Electrochromic windows can lower building heating, cooling & lighting needs by 20%. In addition, these windows may provide shade, glare reduction, and ultimately lead to improved worker productivity.

Electrochromic glass (also known as electrochromic glazing) in the automotive industry is currently used in small surface rear-view and side-mirrors. The automotive industry is interested in expanding the products into sunroofs and side windows to improve the passenger experience (particularly as ride-sharing puts more passengers in the back seat). Air conditioning systems cool, heat, and ventilate the interior of vehicles. These air conditioning systems are electrically powered, and their use can particularly reduce electric vehicle (EV) range by 30-40%, depending upon the size of the air conditioning system, climate, and the driving cycle. Smart glass windows can help manage the interior climate of vehicles, thus reducing air conditioning usage, and extending the range of EVs. Therefore, when used in transportation, these windows can result in vehicles with improved energy efficiency.

In the case of vehicle glazing (such as for sunroofs and moonroofs), there is generally a preference or requirement for curved surfaces to maintain aerodynamic and aesthetic properties. Other examples where curved electrochromic devices may be utilized include architectural windows, ski goggles, eyewear, rear view mirrors, vehicle windows, and skylights. In some cases, these applications require doubly curved (compound curved) or complexly curved surfaces.

U.S. Pat. No. 5,953,150, for example, discloses a method for producing curved electrochromic devices for lenses. Here, the electrochromic layers are deposited onto separate ITO coated plastic substrates, and the two substrates are laminated using an ion-conducting polymer. The above patent uses a vacuum deposition method to apply the functional coatings. Sputtering, a vacuum deposition process, is an industrial process commonly employed to deposit thin films, layers and coating. However, it is difficult to achieve even coverage on curved surfaces with sputtering. In addition, areas of the curved substrates will be closer to the sputtering target, and therefore will experience a higher amount of heat; depending upon the type of substrate, this could lead to issues (e.g., thermoplastic substrates could deform). Furthermore, distribution of the sputtered material can change with time as the target erodes, it is an expensive process, and the method is known to produce pinholes.

To overcome the challenges of sputtering on curved surfaces, alternate manufacturing methods for producing curved electrochromic devices were developed, whereby flat substrates are coated and subsequently formed into curves after the electrochromic stack has been deposited.

U.S. Pat. No. 7,808,692 discloses a method of manufacturing permanently curved electrochromic devices whereby the electrochromic devices are formed by first coating thermoplastic substrates which can subsequently be curved by thermoforming the substrates into a permanent curvature.

U.S. Pat. No. 10,663,831 discloses a method of making a curved electrochromic film by first forming a flat electrochromic film then disposing a UV curable layer between the first and second electrochromic materials, then using a forming apparatus to bend the film, then curing the UV curable layer using a UVlight source while the film is in the arched position.

Issues, however, can arise when bending flat electrochromic films or layers. Depending upon the curvature required, the stress of the bend can be too great and can result in delamination, cracking, or other separation of layers within the electrochromic stack.

Other coating methods, such as curtain coating or slot die coating, have their own set of challenges associated with coating curved surfaces. In some cases, the coating set up would need to be retooled for each substrate with a different curvature or size. Furthermore, these wet-layer application methods may cause uneven layers as the coating may pool or streak on a curved substrate due to gravity, surface tension and or capillary forces.

U.S. Pat. No. 10,871,695 discloses an electrochromic multi-layer device comprising electrically conductive layers that vary as a function of position. Therein, it is stated that electrochromic architectural windows typically employ substrates with flat surfaces, but that it is contemplated that the multi-layer devices may have a single or a doubly curved surface. However, a method for making said curved devices is not disclosed.

US Patent Publication US 2019/0196289A1 discloses curved electrochromic devices wherein the electrochromic compound may be applied to the electrolyte membrane or to the transparent conducting oxide layer on the domes (curved surfaces). The application states that, preferably, the electrochromic compound is applied to an electrolyte membrane prior to complete cure of the membrane. The disclosure relates to organic electrochromic compounds, such as poly(3,4-ethylenedioxythiophene) (PEDOT), which are known to have durability issues and tend to be size limited when compared to electrochromic metal oxides.

The bending process of substrates, especially glass, can be a significant source of failure or introduction of material imperfections. Therefore, it is advantageous to complete the bending of the substrate prior to applying potentially costly electrochromic layers when manufacturing curved electrochromic devices.

There is therefore a need for convenient methods of manufacturing curved, doubly curved or complex-curved electrochromic devices that reliably produce electrochromic coatings of uniform thickness that are applied to already curved substrates.

### SUMMARY OF THE INVENTION

An object of the present invention is to provide a method for manufacturing curved electrochromic devices. In accordance with an aspect of the present invention, there is provided a method for manufacturing a curved electrochromic device comprising the steps of: providing a first curved substrate having a first transparent conductive coating on one surface; coating said first conductive coating with a cathodic electrochromic metal oxide layer, wherein the cathodic electrochromic metal oxide layer material is formed by a process comprising the steps of: i) spray coating the first transparent conductive coating on the first curved substrate with a solution comprising one or more inorganic or organometallic cathodic precursors to form a precursor layer; and ii) exposing the precursor layer to near-infrared radiation, UV radiation, or ozone to convert the one or more inorganic precursors to the first cathodic electrochromic metal oxide layer to form a first coated curved substrate; providing a second curved substrate having a second transparent conductive coating on one surface, wherein the second curved substrate has a complementary curvature to the first curved substrate; coating said second conductive coating with an anodic electrochromic metal oxide layer, wherein the anodic electrochromic metal oxide layer material is formed by a process comprising the steps of: iii) spray coating the second transparent conductive coating on the second curved substrate with a solution comprising one or more inorganic or organometallic anodic precursors to form a precursor layer; and iv) exposing the precursor layer to near-infrared radiation, UV radiation, or ozone to convert the precursor layer to the anodic electrochromic metal oxide layer to form a second coated curved substrate; incorporating an electrolyte layer between said cathodic electrochromic metal oxide layer on the first coated curved substrate and said anodic electrochromic metal oxide layer on the second coated curved substrate; and sealing the device to form the curved electrochromic device, wherein said step of sealing may occur before or after the incorporation of said electrolyte.

In accordance with another aspect of the present invention, there is provided a curved electrochromic device manufactured using the methods of the present invention.

### BRIEF DESCRIPTION OF THE DRAWINGS

The particular arrangements shown in the Figures should not be viewed as limiting. It should be understood that the illustrated elements, including and the shape, size and scale, are not drawn in actual proportion to each other.

Further features and advantages of the present disclosure will become apparent from the following detailed description, taken in combination with the appended drawings, in which:

FIG. 1 is a schematic depiction of a curved electrochromic device and its components, which may be prepared using the method of the present invention, in accordance with one embodiment.

FIG. 2 is a graph showing the change in CIE Y transmittance for the bleached and colored states over 30 cycles for a curved electrochromic device prepared in accordance with one embodiment of the present invention.

### DETAILED DESCRIPTION

The method of the present invention provides an improved method of manufacturing a curved electrochromic device. Furthermore, the present invention presents a method for the uniform and efficient coating of curved, rigid substrates for use in electrochromic devices.

The present disclosure relates in general to methods for manufacturing curved electrochromic devices wherein the curved electrochromic device is prepared by applying the electrochromic layers directly on to rigid curved substrate surfaces.

The method of manufacturing a curved, rigid electrochromic device comprises providing a first curved substrate having a first transparent conductive coating on one surface; and a second curved substrate having a second transparent conductive coating on one surface having a complementary curvature to the first curved substrate. A first (cathodic) electrochromic metal oxide layer is applied to the conductive coating on the first substrate by a process comprising the steps of: i) coating the curved substrate coated with a first transparent conductive coating with a solution of one or more inorganic or organometallic precursors to form a precursor layer; and ii) exposing the precursor layer to near-infrared radiation, UV radiation, or ozone to convert the one or more inorganic or organometallic precursors to a (cathodic) metal oxide layer. The second (anodic) electrochromic layer is applied to the second curved substrate using the same process described for the first curved substrate, but employing a solution of inorganic or organometallic precursors to form an anodic metal oxide layer. Once the first and second curved substrates have been formed with their respective electrochromic metal oxide layers, an electrolyte layer is incorporated between said first and second electrochromic metal oxide layers. The resulting layered structure is sealed to form the curved electrochromic device.

The method of the present invention provides scalable, solution-based processes for manufacturing curved electrochromic devices.

Unless the context requires otherwise, throughout this specification and claims, the words “comprise”, “comprising” and the like are to be construed in an open, inclusive sense. The words “a”, “an”, and the like are to be considered as meaning at least one and not limited to just one.

Unless defined otherwise, all technical and scientific terms used herein have the same meaning as commonly understood by one of ordinary skill in the art to which this invention belongs.

As used herein, the term “singly curved” refers to surfaces that have its radius in one plane.

As used herein, the term “doubly curved” refers to surfaces that have radii in two planes (the surfaces bend in two directions at the same time). An example of such a surface would be a sphere. The term “compound curved” is another term that is used interchangeably for doubly curved herein.

As used herein, the term “complexly curved” refers to curved surfaces that have more than two radii or multiple different curvatures across its surface.

As used herein, the term “anodic electrochromic layer” refers to a layer comprising a solid-state inorganic electrochromic material that transitions to its colored-state when ions are extracted. In the present application, it is located parallel to and positioned in between an electrically-conductive layer and an ion-conducting layer within an electrochromic device.

As used herein, the term “cathodic electrochromic layer” refers to a layer comprising a solid-state inorganic electrochromic material that transitions to its colored-state when ions are inserted. In the present application, it is located parallel to and positioned in between an electrically-conductive layer and an ion-conducting layer within an electrochromic device.

As used herein, the term “cycled” refers to the application of a bias voltage across the device by an external power source such as a battery or a potentiostat, and then, after a prescribed time, reversing the polarity. The reversed polarity may have a different voltage than the original bias voltage. The bias polarity is again reversed and a ‘cycle’ is complete.

As used herein, the term “electrochromic device” refers to an electrochemical device comprising a substrate, an anodic electrode, a cathodic electrode, an ion-conductive layer, and charge-balancing ions, and which device is capable of transitioning from a colored state (i.e., low transmittance of light through the window) to a transparent state (i.e., high transmittance of light through the window), and/or from a transparent state to a colored state, through the use of an applied electrical bias. The “transparent” state may also be referred to as a “bleached” state.

As used herein, the term “ion-conducting” refers to the ability of a material to shuttle ions between different sites. As an example, the ion-conducting material herein is capable of shuttling lithium ions between the anode and cathode upon the introduction of an external electrical bias.

As used herein, the term “ligand” refers to any chemical group coordinated, chemically bonded or ionically bonded to a metal or metalloid. Typical ligand examples are, but not limited to, chloride, bromide, nitrate, 2-ethylhexanoate, ethoxide, butoxide, isopropoxide, acetate, oxalate, and acetylacetonate.

As used herein, the term “photodeposition” refers to the process where chemical precursors that have been solution deposited onto a substrate or electrode, are exposed to UV or NIR electromagnetic radiation, or a combination thereof (in the presence or absence of ozone), resulting in the photochemical conversion to an inorganic, oxide layer.

As used herein, the term “substrate” refers to a mechanically-supportive material upon which additional functional layers are assembled.

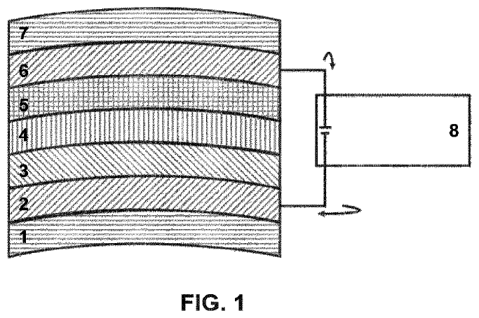

FIG. 1 schematically depicts the multilayer architecture of an electrochromic device that can be prepared using the methods of the present invention. In this case, FIG. 1 represents a device that is connected to an external power source. The electrochromic device includes a first curved substrate (1), a first transparent conductive layer (2), an anodic electrochromic layer or ion-storage layer (3), an ion-conductive electrolyte layer (4), a cathodic electrochromic layer (5), a second transparent electrically-conductive layer (6), and a second curved substrate (7). The substrates (1,7) provide a base structure for the active device materials and protection for the internal layers. The (transparent) electrically-conductive layers (2, 6) provide a means for conducting charge to and from the electrochromic layers (3, 5) from an external power source and/or control electronics and software (8). The conductive electrolyte layer (4) provides a means to transport ions between the anodic (3) and cathodic (5) electrochromic layers. It is within the scope of the present invention that the order of the layers may be reversed with respect to the substrate. That is, the layers can be in the following order: first substrate, first transparent conductive layer, cathodic electrochromic layer, electrolyte layer, anodic electrochromic layer or ion-storage layer, second transparent conductive layer, and second substrate. It is also within the scope of the present invention that additional protective and functional layer(s) may also optionally be applied. The thickness of the layers of the device, including and the shape, size and scale of layers is not drawn to scale or in actual proportion to each other, but is represented for clarity.

When a voltage is applied across the electrodes, an electric field is generated within the insulating electrochromic material, which can cause migration of ions to or from the electrochromic material, producing color changes in that electrochromic material (e.g., from colourless to a coloured state, when it is switched from one electrochromic state to another). By reversing the applied bias, the electrochromic material can be switched back, e.g., from a coloured to colourless (or to its bleached state). The electrochromic material may also be coloured initially, and switch to a colourless state with applied voltage, and then switched back to the coloured state by reversing the applied bias. (For example, tungsten oxide-based materials colour with ion insertion, whereas nickel oxide-based materials colour with ion extraction)

When producing electrochromic devices, there are many potential failure points that may be encountered during the manufacturing process. It is ideal to stop the production of a device as early in the fabrication process as possible if a flaw in the materials is detected. Given that the process for curving the substrate can be a significant source of failure or introduction of material defects, it is advantageous to perform the curving operation before applying potentially expensive functional layers to the substrate material.

The curved transparent substrates (1, 7) may include, but are not limited to glass, plastic and/or polymers. The transparent substrates should have suitable optical, electrical, thermal, and mechanical properties for the desired application. In one embodiment, the curved transparent substrates are selected from the group consisting of glass, polyethylene terephthalate (PET), polycarbonate, polyethylene naphthalate (PEN), polyvinyl butyral (PVB), polymethyl methacrylate (PMMA), acrylic, transparent acrylonitrile butadiene styrene (ABS), methyl methacrylate acrylonitrile butadiene styrene (MABS), polyvinyl chloride (PVC), amorphous copolyester (PETG), general purpose polystyrene, styrene acrylonitrile resin (SAN), styrene methyl methacrylate (SMMA), fluorinated ethylene propylene (FEP), transparent polypropylene, ionomer resin, polyethylene (PE), cyclic olefin copolymers, thermoplastic polyurethane (TPU), and liquid silicone rubber (LSR). In a preferred embodiment, curved transparent substrates are selected from the group consisting of glass, polyethylene terephthalate (PET), polycarbonate, polyethylene naphthalate (PEN), polyvinyl butyral (PVB), polymethyl methacrylate (PMMA), acrylic, and polyvinyl chloride (PVC).

If the substrates are made of glass, they may further include a sodium barrier layer. It is within the scope of the present invention that the first transparent substrate and the second transparent substrate may be of the same material or different materials. In one embodiment, both curved transparent substrates are glass. In another embodiment, both curved transparent substrates are tempered glass or heat strengthened glass. In another embodiment, both curved transparent substrates are polycarbonate. In another embodiment, the curved transparent substrates are independently glass, polycarbonate or polyethylene terephthalate.

It is an advantage of the methods of the present invention that it permits the use of curved tempered glass substrates and heat-strengthened substrates.

Tempered glass is regular glass that has been strengthened through controlled thermal or chemical treatments. The tempering process stresses the glass in a way that results in the glass shattering into small pieces when broken, instead of large, jagged pieces. Tempered glass is, therefore, used for its safety in a variety of applications. When exposed to high temperatures, however, the temper of tempered glass weakens, negating its strength and safety benefits of using it initially. Advantageously, the methods described herewith permit the coating of electrochromic materials to be applied directly onto (curved) tempered glass. In addition, the tempering process often results in glass with significant bows (deviations from planarity) due to roller waves and edge kink. The methods of the present invention provide the ability to produce high quality electrochromic devices on previously tempered glass having an uneven or flawed surface.

In one embodiment, the curved transparent substrates are singly curved, resulting in a singly curved electrochromic device. In another embodiment, the curved transparent substrates are doubly curved (or compound curved), resulting in a doubly curved (compound curved) electrochromic device. In yet another embodiment, the curved transparent substrates are complexly curved, resulting in a complexly curved electrochromic device.

In one embodiment, the radius of curvature of the curved transparent substrate is between about 300 mm and about 4000 mm. In another embodiment, the radius of curvature of the curved transparent substrate is between about 750 mm and about 3000 mm. In yet another embodiment, the radius of curvature of the curved transparent substrate is between about 1000 mm and about 2000 mm.

In one embodiment, both curved transparent substrates are glass. In another embodiment, both curved transparent substrates are tempered glass or heat strengthened glass. In another embodiment, both curved transparent substrates are polycarbonate. In another embodiment, the curved transparent substrates are independently glass, polycarbonate or polyethylene terephthalate.

The invention also permits an electrochromic device with a rigid curved substrate as the first curved substrate to be combined with a flexible substrate as the second curved substrate. Alternatively, the configuration of the substrates may be reversed such that the first curved substrate is a flexible substrate and the second curved substrate is a rigid curved substrate.

In accordance with the methods of the present invention, the respective curved substrates (1, 7) are each provided with transparent conductive layers (2, 6), The transparent conductive coatings (2, 6) typically are coatings comprising a transparent conductive oxide (TCO). The conductive coatings should provide sufficient conductance for the electrochromic device and should not appreciably interfere with the transmission of light. The transparent conductive coatings on each of the substrates may be of the same material or different materials. In one embodiment, the transparent conductive coating comprises fluorine tin oxide (FTO); indium tin oxide (ITO); aluminum zinc oxide (AZO), silver mesh, silver nanowires, silver nanoparticles, carbon nanotubes, carbon black, graphene, conductive polymers, or a combination of two or more thereof. In a preferred embodiment, the transparent conductive coating comprises FTO or ITO.

ITO coated glass has a preferred maximum use temperature of under 350° C., while FTO coated glass coatings can be used at temperatures up to 600° C. Hence, some higher temperature processes of prior art methods of the manufacture of electrochromic substrates, for example sol-gel techniques, are not amenable for use with ITO coated substrates. By contrast, the low temperature spray-coating and photodeposition steps of the present methods permit the process to be carried out on substrates coated with ITO or FTO.

### Electrochromic Layers

Efficient electrochromic layers (3, 5) exhibit a high color contrast between their colored and bleached states, have rapid conversion between coloured and bleached states, are capable of switching at low applied voltage, and show excellent reversibility with cycling between states.

There are different types of electrochromic materials that can be used in electrochromic devices, including organic dyes and surface-confined electrochromic layers, such as metal oxides. The majority of the architectural electrochromic windows on the market today employ metal oxides, as the metal oxides are more durable than their organic counterparts, and generally switch more uniformly when used on larger area windows. In a preferred embodiment, the electrochromic devices of the present invention employ metal oxide based electrochromic coatings.

Generating active (electrochromic) metal oxide or mixed-metal oxide layers is a critical step in the manufacture of oxide-based electrochromic cells. Historically, sputtering, an in vacuo physical vapour deposition method (including in dc magnetron, electron beam and radio frequency) has been the most widely used method of thin film (layer) and coating deposition in the electrochromic industry. While very versatile, sputtering requires a vacuum chamber, high energy to operate, and faces challenges related to the formation of uniform coatings on curved surfaces.

Alternative techniques to sputtering, such as slot die coating and curtain coating, are not easily amenable to coating curved surfaces, especially if the radius of curvature of the material being coated varies. Slot die requires the surface being coated to be flat, with a restriction in curvature and waviness relative to the thickness of the meniscus of the slot die. Curtain coating is not practical on curved surfaces as gravity can cause the solution to flow down the slope of the curved substrate resulting in uneven coating. In contrast to these prior art methods for applying coatings to curved surfaces, the methods of the present invention allow for the application of uniform coatings on rigid curved substrates of varying curvatures.

In accordance with a preferred embodiment of the present invention, the electrochromic coatings are applied using a spray-coater. In one embodiment of the invention, the curved substrate is moved under a stationary spray-coater nozzle from which the solution of one or more inorganic or organometallic precursors is expelled. In an alternative embodiment, the substrate remains stationary, and the spray-coater nozzle moves over the curved substrate to coat the entire substrate area. In yet another embodiment, both the substrate and spray-coater nozzle are moved relative to each other.

Using the methods of the present invention, the resulting electrochromic coatings can be prepared to a desired thickness according to requirements. In one embodiment, the thickness is controlled by controlling the speed of the movement of the spray-coater nozzle and/or the substrate. In one embodiment, the spray-coater nozzle is moved relative to the surface of the curved substrate at a rate of between 20 and 50 feet per minute.

In one embodiment, slowing the rate of the substrate or nozzle movement produces good results using a single pass. In another embodiment, the substrate area is exposed to the spray coating solution multiple passes until the desired thickness is achieved.

In accordance with the methods of the present invention, the coating solution is a solution of one or more inorganic or organometallic precursors. This solution is prepared by dissolving a metal precursor or precursors into a compatible solvent and then applying the solution to the surface of the substrate. Upon drying, a layer of the desired precursor or precursors is formed on the substrate. Examples of compatible solvents include but are not limited to water, methanol, ethanol, isopropanol, acetone, hexane and methyl isobutyl ketone, propylene glycol methyl ether acetate (PGMEA), ethyl acetate, acetonitrile, ethylene glycol, tetrahydrofuran (THF), toluene, and N-methylpyrrolidone. Any solvent which can dissolve the precursor may be suitable for use in the present methods.

In a representative electrochromic device, one of the curved transparent conductive substrates includes a cathodic electrochromic layer and, and the other of the curved transparent conductive substrates includes an anodic electrochromic layer.

Tungsten oxide (“WOx”) is a well-known cathodic electrochromic material that cycles between a pale yellow (or transparent) fully oxidized state and deep blue partially reduced state in electrochromic devices. The transparent material can be electrochemically reduced in the presence of lithium ions to form the coloured, reduced state (“LiWOx”), and reversibly re-oxidized to the transparent state. Examples of other electrochromic cathodic materials suitable for use in the devices of the present invention include, but are not limited to, molybdenum oxide (“MoOx”), titanium oxide (“TiOx”), tantalum oxide (“TaOx”) and niobium oxide (“NbOx”).

Nickel oxide (“NiOx”) is a known anodic electrochromic material that colours complementary to tungsten oxide to create a better coloured dark state in the electrochromic cell. Deposition of NiOx layers is typically performed by sputtering. Another example of an anodic electrochromic material suitable for use in the devices of the present invention is iridium oxide. Materials such as cobalt oxide (“CoOx”), manganese oxide (“MnOx”) and iron oxide (“FeOx”) have also been shown to exhibit electrochromic behaviour, but are not ideal as they do not bleach completely. Vanadium oxide (“VOx”) is another well-known anodic electrochromic material.

In one embodiment, the electrochromic layers comprise metal oxides selected from the group consisting of NiOx, WOx, MoOx, TiOx, TaOx, VOx, NbOx, CoOx, IrOx, MnOx, FeOx, LiNiOx, WNbOx, TiWOx, LiWOx, NiNbOx, NiNbLiOx, NiAlLiOx, or a combination thereof. In a preferred embodiment, the cathodic electrochromic layer is WOx, WNbOx, TiWOx, LiWOx, or combinations thereof. In a preferred embodiment, the anodic electrochromic layer comprises NiOx, LiNiOx, NiNbOx, NiNbLiOx, NiAlLiOx, VOx, or combinations thereof. In one embodiment, the electrochromic metal oxide layer is predominantly composed of tungsten oxide. In one embodiment, the electrochromic metal oxide layer is predominantly composed of nickel oxide.

In one embodiment, the electrochromic metal oxide layer is a doped metal oxide and the dopant atom is selected from niobium, aluminum, cerium, lithium, tantalum, molybdenum, cobalt, silicon, and titanium.

Precursors suitable for use in the various processes of the present invention include any inorganic or organometallic compound that can be converted to the corresponding oxide upon exposure to photodeposition. Suitable precursors include, but are not limited to, an inorganic chloride, an inorganic nitrate, an inorganic acetate, an organometallic 2-ethylhexanoate, an organometallic butoxide, an organometallic ethoxide, an organometallic methoxide, an organometallic isopropoxide, an organometallic acetylacetonate, an organometallic silanolate, an organometallic oxalate, or mixtures thereof. Exemplary embodiments of precursors include tungsten (VI) chloride, tungsten (VI) isopropoxide, vanadium (Ill) chloride, tantalum (V) ethoxide, niobium (IV) 2-ethylhexanoate, niobium (V) ethoxide, nickel (II) acetate tetrahydrate, nickel (II) 2-ethylhexanoate, lithium methoxide, lithium ethoxide, lithium 2-ethylhexanoate, lithium trimethylsilanolate, and molybdenum (IV) 2-ethylhexanoate.

In one embodiment, the present invention provides a method for preparing a curved electrochromic device comprising, in part, the steps of spray coating a curved rigid substrate with a precursor solution in order to form a precursor layer on the substrate, then, subjecting the layer to photodeposition to convert the precursor layer coated on the substrate to the desired metal oxide or mixed-metal oxide.

The photodeposition step can be carried out by exposure of the precursor layer to one or more of near-infrared radiation, UV radiation, and ozone.

Near infrared photodeposition uses infrared light to decompose a precursor to generate the corresponding inorganic, solid-state ion-conductive layer. U.S. Pat. No. 10,173,210 describes the Near Infrared (NIR) driven decomposition method for the preparation of metal oxides and mixed-metal oxides, the entire disclosure of which is incorporated herein by reference in jurisdictions allowing such incorporation.

UV photodeposition operates at either ambient or elevated temperatures and relies on ultraviolet light, or a combination of ultraviolet light and ozone, to convert a precursor to the corresponding inorganic, solid-state ion-conductive layer. U.S. Pat. No. 9,803,287 describes a UV photodeposition technique for generating metal oxides and mixed-metal oxides for making electrocatalysts, the entire disclosure of which is incorporated herein by reference in jurisdictions allowing such incorporation.

U.S. Patent Application No. US20200165161A1 describes the photodeposition techniques for generating metal oxides and mixed-metal oxides for making electrochromic layers and devices, the entire disclosure of which is incorporated herein by reference in jurisdictions allowing such incorporation.

In one embodiment of the fabrication of an electrochromic layer on the substrate, a precursor solution is prepared and coated on the appropriate surface as described above, and the resultant precursor thin layers are subjected to the photodeposition process until decomposition is confirmed through monitoring ligand loss using analytical methods. In embodiments of the invention where precursors comprise organic ligands, formation of the desired metal oxide can be monitored by infrared (IR) or Fourier transform infrared (FTIR) spectroscopy, as loss of ligands from the precursor gives rise to a loss of ligand signal in the infrared spectrum. For precursors which cannot be tracked by infrared spectroscopy, including but not limited to metal chloride salts, X-ray fluorescence (XRF) spectroscopy can be used to monitor the transformation to the metal oxide.

In some embodiments, the electrochromic precursor layer is composed of multiple layers and is subjected to photodeposition between each layer. In another embodiment, the electrochromic precursor layer is composed of multiple layers and is subjected to the photodeposition process only after all layers of the precursor have been applied. In another embodiment, the electrochromic precursor layer is composed of multiple layers and is subjected to the photodeposition process after every second, third, or fourth layer of the precursor has been applied. In another embodiment, the electrochromic precursor layer is composed of multiple layers and is subjected to photodeposition after every fifth, sixth or seventh layer of the precursor has been applied.

In one embodiment, the resulting electrochromic metal oxide layer may undergo an annealing step, e.g. at a temperature of from about 30° C. to about 600° C. In certain embodiments, the electrochromic metal oxide layer undergoes an annealing step in an oven in atmospheric air at temperatures ranging from about 30 to about 600° C. for about 15 minutes to about 1 hour. In one embodiment, the layers undergo an annealing step at about 50° C. for about 15 minutes to about 1 hour. In one embodiment, the layers undergo an annealing step at about 100° C. for about 15 minutes to about 1 hour. In another embodiment, the layers undergo an annealing step at about 200° C. for about 15 minutes to about 1 hour. In yet another embodiment, the layers undergo an annealing step at about 300° C. for about 15 minutes to about 1 hour. In another embodiment, the layers undergo an annealing step at about 350° C. for about 15 minutes to about 1 hour. In another embodiment, the layers undergo an annealing step at about 400° C. for about 15 minutes to about 1 hour. In yet another embodiment, the layers undergo an annealing step at about 450° C. for about 15 minutes to about 1 hour.

In one embodiment, the electrochromic layer is an average thickness of about 10 nm to about 2000 nm. In another embodiment, the electrochromic layer is an average thickness of about 100 nm to about 800 nm. In a preferred embodiment, the average thickness of the electrochromic layer is about 200 nm to about 700 nm.

In certain embodiments, an additional layer is added to the electrochromic layer on either or both of the curved transparent substrates. In one embodiment, this additional layer is a barrier layer. In certain embodiments, this additional barrier layer comprises niobium oxide, lithium oxide, titanium oxide, tantalum oxide, cerium oxide, zirconium oxide, aluminum oxide, or a mixture thereof. In another embodiment, the barrier layer comprises niobium oxide, zirconium oxide, lithium oxide, or a mixture thereof.

In the electrochromic devices of the present invention, the anodic electrochromic layer and cathodic electrochromic layer are separated by an ion-conducting electrolyte layer (4). The role of the electrolyte layer (4) in an electrochromic cell is to allow ions and current to travel between the anode and cathode materials. This layer can be liquid, gel or solid-state. In one embodiment, the electrolyte layer is an electrolytic solution comprises a lithium salt dissolved in propylene carbonate. In one embodiment, the electrolyte layer is a polymer gel comprising: a resin; a lithium salt; a solvent component; an optional plasticizer component; and an optional cross-linking agent. In another embodiment, the electrolyte layer is a polymer gel comprising a difunctional oligomer; a monofunctional monomer, a lithium salt, a plasticizer and a photoinitiator. In yet another embodiment, the electrolyte layer is a solid-state layer comprising at least one ion-conducting metal oxide material.

Additives may be incorporated into the electrolyte layer in order to enhance performance or durability of the layer. Such additives may include, but are not limited to, fillers, ultraviolet stabilizers, heat stabilizer, adhesion improvers, antioxidants, radical scavengers, moisture scavengers, cross linkers, ultraviolet light absorbers, pigments, dyes, IR absorbers or blockers, surfactants, cheating agents, and impact modifiers, in addition to other additives known to those skilled in the art.

The electrolyte layer is sealed between the anodic electrochromic layer and cathodic electrochromic layer to isolate the interface of the electrolyte from the outside atmosphere. In one embodiment, the sealing step employs a hot melt material that melts and seals as the electrolyte is cured. In one embodiment, the sealing step employs a double-sided tape. In one embodiment, the sealing step employs a material that is applied followed by a curing step to initiate hardening.

In one embodiment of the present invention, tungsten oxide is formed onto a curved transparent conductive oxide coating by subjecting a tungsten precursor layer to photodeposition and subsequently incorporated into a curved electrochromic cell—a cell that is capable of transitioning transparency from opaque to transparent or transparent to opaque through the use of an applied electrical bias.

In another embodiment of the present invention nickel oxide is formed onto a curved transparent conductive oxide coating by subjecting a nickel precursor layer to photodeposition or thermal decomposition and subsequently incorporated into a curved electrochromic cell—a cell that is capable of transitioning transparency from opaque to transparent or transparent to opaque through the use of an applied electrical bias.

Relevant electrochromic devices prepared according to embodiments of the invention may include but are not limited to electrochromic windows and electrochromic sunroofs.

This invention permits an electrochromic device with a rigid curved surface for one substrate to be combined with a flexible substrate. In such an embodiment, the electrochromic device includes a flexible first substrate, and a rigid second substrate. In another embodiment, the electrochromic device includes a rigid first substrate, and a flexible second substrate.

The invention will now be described with reference to specific examples. It will be understood that the following examples are intended to describe embodiments of the invention and are not intended to limit the invention in any way. It will be understood that certain aspects of the disclosed processes can be arranged and combined in a wide variety of different configurations, all of which are contemplated herein.

### EXAMPLES

### Example 1—Preparing Electrochromic WOx on a Curved Surface

The 12 inch by 12 inch fluorine-doped tin oxide (FTO) coated glass substrates (TEC 10; 10 Ω/sq) (Pilkington, Toledo, OH, USA) were bent to result in a radius of curvature of two meters as measured at the middle of the assembled electrochromic device (Coastal Curved Glass, Pitt Meadows, BC, Canada). The curved substrates were cleaned with sequential sonication in the following solutions for 15 minutes each: Extran®300 detergent (VWR, Mississauga, ON, Canada); deionized H₂O; acetone (VWR, Mississauga, ON, Canada); and 2-propanol (VWR, Mississauga, ON, Canada). The substrate was dried and the concave surface was rastered with atmospheric plasma for five to eight minutes. All four edges of the concave side of the cleaned substrate were masked, and the substrate was then spray coated. For the precursor solution, 2-propanol (VWR, Mississauga, ON, Canada) was added to tungsten (VI) chloride (WCI6, Sigma Aldrich, Oakville, ON, Canada) to make a 0.05 M solution. This solution was filtered and spray-coated (arm speed=10 cm/s;) onto a curved FTO-coated glass substrate, yielding a blue layer on the substrate. The spray process was repeated two more times. The coated substrate was then placed in a UV reactor, (dual wavelength (λ=185, 254 nm) UV lamp (05-0332-R GPH436T5VH/HO/4PSE, 4 Pin Ozone, Atlantic Ultraviolet, Hauppauge, NY, USA) for 5 minutes. for conversion of the precursor to form WOx. The cast thin layer turned from blue to colourless and was converted to a thin layer made of a metal oxide, WOx in this case. The spray/UV process was repeated six times. The mask was removed. Precursor conversion was followed by X-ray fluorescence (XRF) spectroscopy, and was considered complete when counts corresponding to the precursor chloride ligand had disappeared or reached a baseline level.

### Example 2—Preparing Electrochromic NiOx on a Curved Substrate

The 12 inch by 12 inch fluorine-doped tin oxide (FTO) coated glass substrates (TEC 10; 10 Ω/sq) (Pilkington, Toledo, OH, USA) were bent to result in a radius of curvature of two meters as measured at the centre of the assembled electrochromic device (Coastal Curved Glass, Pitt Meadows, BC, Canada). The curved substrates were cleaned with sequential sonication in the following solutions for 15 minutes each: Extran®300 detergent (VWR, Mississauga, ON, Canada); deionized H₂O; acetone (VWR, Mississauga, ON, Canada); and 2-propanol (VWR, Mississauga, ON, Canada). The substrate was dried and the convex surface was rastered with atmospheric plasma for five to eight minutes. All four edges of the convex side of the cleaned substrate were masked, and the substrate was then spray coated. For the precursor solution, 2-propanol (VWR, Mississauga, ON, Canada) was added to Nickel(II) 2-ethylhexanoate (78% in 2-ethylhexanoic acid) ((Ni(eh)2), Strem, Newburyport, Massachusetts, United States) to make a 0.18 M solution. This solution was filtered and spray-coated (arm speed=10 cm/s) onto a curved FTO-coated glass substrate yielding a colourless layer on the substrate. The spray process was repeated five times. The mask was removed. The substrate was then placed in an oven (Memmert UF 160 PLUS) and heated for conversion of the precursor to form NiOx. The cast thin layer turned from colourless to light brown and was converted to a thin layer made of a metal oxide, NiOx in this case. The coated substrate was then remasked and sprayed with a 0.20 M solution of nickel precursor (3 times). The mask was removed and the coated substrate was put in an oven for conversion to the oxide (same oven conditions as described above). This spray/oven process with the 0.20 M solution was repeated an additional time. Precursor conversion was followed by Fourier transform infrared fluorescence (FTIR) spectroscopy and was considered complete when stretches corresponding to the corresponding precursor ligands had disappeared or reached a baseline level.

### Example 3—Curved Electrochromic Device

In this example, an electrochromic WOx layer prepared as described in Example 1 and the NiOx flayer as described in Example 2 were incorporated into a liquid electrochromic device with a structure of glass/FTO/WOx/LiCIO4 in PC/FTO/glass.

Copper tape (McMaster-Carr, Robbinsville, NJ, USA) busbars were attached to the bare FTO along two connected edges on the coated side of the WOx substrate, and silver paint (Ted Pella, Redding, CA, USA) was applied along the edges of the copper tape where it is in contact with the FTO.

Copper tape (McMaster-Carr, Robbinsville, NJ, USA) busbars were attached to the bare FTO along two connected edges on the coated side of the NiOx substrate, where the two edges will be on the edges that are opposite from those on the WOx pieces when assembled (so it appears the whole device has a perimeter of copper tape)).

Double sided 3M™ VHB™ tape (4910, ¾″, 40 mil) was applied to the perimeter of one of the coated electrodes, and the two electrodes were sandwiched together, coated sides facing each other with curvature complimentary. The VHB™ tape was wide enough to cover the busbar so as to prevent liquid electrolyte from coming into contact with them. Edges were pressed together to ensure a good seal.

A 1 M solution of battery grade lithium perchlorate (LiClO₄, Sigma Aldrich, Oakville, ON, Canada) in anhydrous propylene carbonate (PC, Sigma Aldrich, Oakville, ON, Canada) was injected into the cell using a syringe and blunt needle. This was done carefully to prevent air bubbles within the device. A second blunt needle was inserted on the opposite side to act as a vent while injecting the electrolyte. Once filled, the needles were removed.

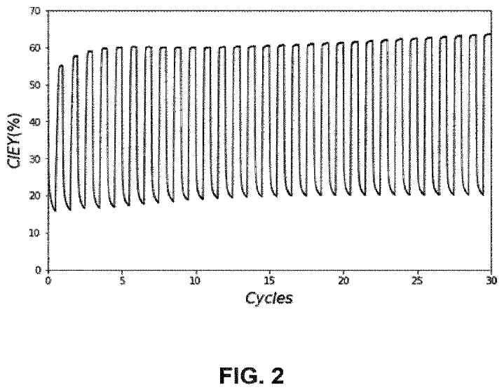

The electrochromic performance of the electrochromic device described was tested via a coupled UV-Vis spectroscopy—electrochemistry set up. The working electrode potentiostat lead was connected to the copper tape busbar that was in contact with the FTO on the coated WOx electrode. The counter electrode and reference electrode were connected to a copper tape busbar that was in contact with the FTO on the coated NiOx electrode. The switching times of the device (from bleached to colored and colored to bleached) were measured by applying alternating consecutive −1.7 V and +1.7 V voltages to the device at 300 second intervals. The change in transmittance at CIE Y scale for the electrochromic device as a function of time was recorded. FIG. 2 shows a sample of 30 switching cycles for the device.

All U.S. patents, U.S. patent applications, foreign patents, foreign patent applications and non-patent publications referred to in this specification, are incorporated herein by reference in their entirety in jurisdictions that permit such incorporation.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

1. A method for manufacturing a curved electrochromic device comprising the steps of:
providing a first curved substrate having a first transparent conductive coating on one surface;
coating said first conductive coating with a cathodic electrochromic metal oxide layer, wherein the cathodic electrochromic metal oxide layer material is formed by a process comprising the steps of:
i) spray coating the first transparent conductive coating on the first curved substrate with a solution comprising one or more inorganic or organometallic cathodic precursors to form a precursor layer; and
ii) exposing the precursor layer to near-infrared radiation, UV radiation, or ozone to convert the one or more inorganic precursors to the cathodic electrochromic metal oxide layer to form a first coated curved substrate;
providing a second curved substrate having a second transparent conductive coating on one surface, wherein the second curved substrate has a complementary curvature to the first curved substrate;
coating said second conductive coating with an anodic electrochromic metal oxide layer, wherein the anodic electrochromic metal oxide layer material is formed by a process comprising the steps of:
iii) spray coating the second transparent conductive coating on the second curved substrate with a solution comprising one or more inorganic or organometallic anodic precursors to form a precursor layer; and
iv) exposing the precursor layer to near-infrared radiation, UV radiation, or ozone to convert the precursor layer to the anodic electrochromic metal oxide layer to form a second coated curved substrate;
incorporating an electrolyte layer between said cathodic electrochromic metal oxide layer on the first coated curved substrate and said anodic electrochromic metal oxide layer on the second coated curved substrate; and
sealing the device to form the curved electrochromic device, wherein said step of sealing may occur before or after the incorporation of said electrolyte.

2. The method according to claim 1, wherein steps (i) and (ii) and/or steps (iii) and (iv) are repeated until a desired thickness of the metal oxide layer is achieved to form the active layer.

3. The method according to claim 1, wherein step (i) is repeated more than once before step (ii) occurs.

4. The method according to any one of claims 1 to 3, wherein the step of spray coating is carried out with a spray coater nozzle moving over the substrate to provide a uniform coating of the one or more inorganic or organometallic precursors.

5. The method according to claim 4, wherein the spray coater nozzle moves between 20 feet per minute and 50 feet per minute.

6. The method according to any one of claims 1 to 3, wherein the step of spray coating is carried out with a spray coater nozzle, wherein the spray coater nozzle is stationary and the substrate is moved under the stationary nozzle to provide a uniform coating of the one or more inorganic precursors.

7. The method according to claim 1, wherein the electrochromic metal oxide layer is annealed after step (ii) and/or step (iv).

8. The method according to claim 7, wherein the annealing step is carried out at a temperature of about 30° C. to about 600° C.

9. The method according to claim 7, wherein the annealing step is carried out at a temperature of about 50° C.

10. The method according to claim 7, wherein the annealing step is carried out at a temperature of about 100° C.

11. The method according to claim 7, wherein the annealing step is carried out at a temperature of about 200° C.

12. The method according to claim 7, wherein the annealing step is carried out at a temperature of about 300° C.

13. The method according to claim 7, wherein the annealing step is carried out at a temperature of about 350°.

14. The method according to claim 7, wherein the annealing step is carried out at a temperature of about 400° C.

15. The method according to any one of claims 7 to 14, wherein the annealing step is carried out for about 15 minutes to about 1 hour.

16. The method according to any one of claims 1 to 15, wherein the curved electrochromic device comprises at least one region having a radius of curvature of between about 300 mm and about 4000 mm.

17. The method according to claim 16, wherein the radius of curvature is between about 300 mm and about 1000 mm.

18. The method according to claim 16, wherein the radius of curvature is between about 750 mm and about 3000 mm.

19. The method according to claim 16, wherein the radius of curvature is between about 1000 mm and about 2000 mm.

20. The method according to any one of claims 1 to 15, wherein said curved electrochromic device is a singly curved electrochromic device.

21. The method according to any one of claims 1 to 15, wherein said curved electrochromic device is a compound curved (doubly curved) electrochromic device.

22. The method according to any one of claims 1 to 15, wherein said curved electrochromic device is a complexly curved electrochromic device.

23. The method according to any one of claims 1 to 22, further comprising a step of providing said first electrochromic layer and/or said second electrochromic layer with an additional layer.

24. The method according to claim 23, wherein said additional layer is a barrier layer comprised of niobium oxide, lithium oxide, titanium oxide, tantalum oxide, cerium oxide, aluminum oxide, zirconium oxide, or a mixture thereof.

25. The method according to claim 23, wherein said additional layer is a barrier layer comprised of niobium oxide, zirconium oxide, lithium oxide or a combination thereof.

26. The method according to any one of claims 1 to 25, wherein the first and second electrochromic metal oxide layers comprise metal oxides selected from the group consisting of NiOx, WOx, MoOx, TiOx, TaOx, VOx, NbOx, CoOx, IrOx, MnOx, FeOx, LiNiOx, WNbOx, TiWOx, LiWOx, NiNbOx, NiNbLiOx, NiAlLiOx, or any combination thereof.

27. The method according to claim 26, wherein the first electrochromic metal oxide layer is a cathodic electrochromic layer comprising WOx, WNbOx, TiWOx, LiWOx, MoOx, TiOx, TaOx, NbOx, or any combination thereof.

28. The method according to claim 26, wherein the second electrochromic metal oxide layer is an anodic electrochromic layer comprising NiOx, LiNiOx, NiNbOx, NiNbLiOx, NiAlLiOx, CoOx, IrOx, MnOx, FeOx, VOx, or any combination thereof.

29. The method according to claim 26, wherein the first and/or second electrochromic metal oxide layer is a doped metal oxide and the dopant atom is selected from niobium, cerium, aluminum, lithium, tantalum, molybdenum, cobalt, silicon, and titanium.

30. The method according to claim 27, wherein the cathodic electrochromic metal oxide layer is majority composed of tungsten oxide.

31. The method according to claim 28, wherein the anodic electrochromic metal oxide layer is majority composed of nickel oxide.

32. The method according to any one of claims 26 to 31, wherein the electrochromic layers each have an average thickness of between about 10 nm and about 2000 nm.

33. The method according to any one of claims 26 to 31, wherein the electrochromic layers each have an average thickness of between about 100 nm and about 800 nm.

34. The method according to any one of claims 26 to 31, wherein the electrochromic layers each have an average thickness of between about 200 nm and about 700 nm.

35. The method according to any one of claims 1 to 34, wherein the electrolyte layer is an electrolytic solution.

36. The method according to claim 35, wherein the electrolytic solution is a solution of a lithium salt in propylene carbonate.

37. The method according to any one of claims 1 to 34, wherein the electrolyte layer is a polymer gel comprising:
a polymer resin;
a lithium salt;
a solvent portion comprising one or more solvents;
optionally a plasticizer component; and
optionally a cross-linking agent.

38. The method according to any one of claims 1 to 34, wherein the electrolyte layer is a polymer gel comprising:
a difunctional oligomer;
a monofunctional monomer;
a lithium salt;
a plasticizer component; and
a photoinitiator.

39. The method according to any one of claims 1 to 34, wherein the electrolyte layer is a solid-state layer comprising at least one ion-conducting metal oxide.

40. The method of any one of claims 35 to 39, wherein the electrolyte layer comprises an additive selected from fillers, ultraviolet stabilizers, heat stabilizer, adhesion improvers, antioxidants, radical scavengers, moisture scavengers, cross linkers, ultraviolet light absorbers, pigments, dyes, IR absorbers, IR blockers, surfactants, cheating agents, impact modifiers, or any combination thereof.

41. The method according to any one of claims 1 to 40, wherein the solution of one or more inorganic or organometallic precursors comprise one or more of an inorganic chloride, an inorganic nitrate, an inorganic acetate, an inorganic oxalate, an organometallic 2-ethylhexanoate, an organometallic butoxide, an organometallic ethoxide, an organometallic methoxide, an organometallic isopropoxide, an organometallic acetylacetonate, an organometallic silanolate, an organometallic oxalate, or mixtures thereof.

42. The method according to any one of claims 1 to 41, wherein the first and second curved substrates are independently selected from the group consisting of glass, polyethylene terephthalate (PET), polycarbonate, polyethylene naphthalate (PEN), polyvinyl butyral (PVB), polymethyl methacrylate (PMMA), acrylic, transparent acrylonitrile butadiene styrene (ABS), methyl methacrylate acrylonitrile butadiene styrene (MABS), polyvinyl chloride (PVC), amorphous copolyester (PETG), general purpose polystyrene, styrene acrylonitrile resin (SAN), styrene methyl methacrylate (SMMA), fluorinated ethylene propylene (FEP), transparent polypropylene, ionomer resin, polyethylene (PE), cyclic olefin copolymers, thermoplastic polyurethane (TPU), and liquid silicone rubber (LSR).

43. The method according to any one of claims 1 to 41, wherein the first and second curved substrates are independently selected from the group consisting of glass, polyethylene terephthalate (PET), polycarbonate, polyethylene naphthalate (PEN), polyvinyl butyral (PVB), polymethyl methacrylate (PMMA), acrylic, and polyvinyl chloride (PVC).

44. The method according to any one of claims 1 to 41, wherein the first and second curved substrates are both glass.

45. The method according to claim 44, wherein the glass is tempered glass or heat strengthened glass.

46. The method according to any one of claims 1 to 41, wherein the first and second curved substrates are both polycarbonate.

47. The method according to any one of claims 1 to 41, wherein the first and second curved substrates are independently glass, polycarbonate, polyethylene terephthalate or polyethylene naphthalate.

48. The method according to any one of claims 1 to 47, wherein the transparent conductive coating comprises fluorine tin oxide (FTO), indium tin oxide (ITO), aluminum zinc oxide (AZO), silver mesh, silver nanowires, silver nanoparticles, carbon nanotubes, carbon black, graphene, conductive polymers or a mixture of two or more thereof.

49. The method according to claim 48, wherein the transparent conductive coating comprises fluorine tin oxide (FTO) or indium tin oxide (ITO).

50. The method according to any one of claims 1 to 49, wherein the device is for use as an electrochromic sunroof.

51. The method according to any one of claims 1 to 49, wherein the device is for use as an electrochromic window.

52. The method according to any one of claims 1 to 51, wherein the step of sealing comprises applying a hot melt material between the first coated curved substrate and the coated curved substrate, wherein the hot melt material melts and seals as the electrolyte is cured.

53. The method according to any one of claims 1 to 51, wherein the step of sealing comprises applying a double-sided tape between the first coated curved substrate and the second coated curved substrate.

54. The method according to any one of claims 1 to 51, wherein the step of sealing comprises applying a material that hardens upon curing between the first coated curved substrate and the coated curved substrate.

55. The method according to claim 1, further comprising: coupling one or more electrical leads to the first conductive coating and the second conductive coating.

56. The method according to claim 1, further comprising: applying a voltage between the first conductive coating and the second conductive coating to cause a change in transmission or reflectance of light through the device.

57. A curved electrochromic device manufactured using the method as defined in any one of claims 1 to 56.
